(19) United States
(12) Patent Application Publication
(10) Pub. No.: US 2013/0203497 A1
(43) Pub. Date: Aug. 8, 2013

(54) MONETARY SOCIAL GAMING ENGINE/PLATFORM PROVIDING FREE GAMES AND REAL MONEY GAMBLING

(71) Applicant: Benjamin Thomas Ogden, Windermere, FL (US)

(72) Inventor: Benjamin Thomas Ogden, Windermere, FL (US)

(21) Appl. No.: 13/528,828

(22) Filed: Jun. 20, 2012

Related U.S. Application Data
(60) Provisional application No. 61/596,139, filed on Feb. 7, 2012.

(51) Int. Cl. G07F 17/32; A63F 13/12

(52) U.S. Cl. CPC G07F 17/3225; A63F 13/12
USPC 463/42

(57) ABSTRACT

A system allows people to socially connect with and play games with their friends online for free and for real money. The system allows them to schedule group events where group gaming occurs, and play in tournaments, play in various types of games such as person versus software, person versus another person, or person versus many people games, as well as many people versus many people games. Various individual and group chats and live group discussions can take place. Social connections, subscriptions, and other key data points, such as notifications of important events between friends can be analyzed and organized using a social data organization model (SDOM) to deliver a personalized data feed (PDF), recommendations, real time notifications (RTN) and real time invitations (RTI) which drives social gaming/gambling and solves the social gaming need of play free games and real money gambling games remotely over the internet together in one environment.

### CROSS-REFERENCE TO RELATED APPLICATIONS

This application claims the benefit of priority of U.S. provisional patent application No. 61/596,139, filed Feb. 7, 2012, the contents of which are herein incorporated by reference.

### BACKGROUND OF THE INVENTION

The present invention relates to social gaming engines/platforms and, more particularly, to a monetary social gaming engine/platform providing free games and real money gambling with or without an API allowing external development.

There is a need to be able to socially connect to and play monetary gambling games with friends online, on mobile devices, on tablets and on the television. Users may enjoy playing social games for free and also playing social gambling games for real money, for example. However, currently, these two things are separate and not included in the same social gaming environment, whether that be on the internet, mobile devices, tablets, television or any other type of data transmission device that may be developed.

There are social gaming environments that offer free social gaming with friends, but they do not offer both free social gaming and real money social gambling with friends through the internet. Then, there are real money gambling websites, but they do not provide the social networking connections that come with a monetary social gaming engine, such as friend connections, subscriptions, real time notifications, group events, real time invitations, personalized data feeds, personalized game recommendations, and the like.

There is currently no such monetary social gamine engine (MSGE) that offers both free and real money gambling (real risk monetary gambling—RRMG) in the same social gambling environment with personalized data feed (PDF) and real time notifications (RTNs) real time invitations (RTIs) powering a remote social gaming/gambling experience over the internet.

There is also no monetary social gaming platform offering an application programming interface (API) for external development of both free games and real money gambling games. The only social gaming environments that currently offer an API for external development are limited and only allow play for free games to integrate. There are currently no monetary social gaming environments that have an API which allows the integration of RRMG. The Gambling Components Cycle (GCC) is currently non-existent in any of the current social platforms over the internet.

Currently the free social gaming world and real money online gambling world are segmented. There is no overlap and integration of the free and real money social gambling experience from online, mobile devices, tablets, television and other data transmissions devices.

As can be seen, there is a need for a monetary social gaming engine providing free games and multitudes of real money gambling types, integrated payment processing, player profiles, friend connections, subscriptions, real time notifications, real time invitations, personalized data feeds, chat, messaging, event scheduling, tournaments, group games and has an optional API to allow for outside game development of real risk monetary gambling games on our monetary social gaming engine/platform.

### SUMMARY OF THE INVENTION

In one aspect of the present invention, a social gaming engine comprises a registration system operable to permit users to register with the social gaming engine via an internet connection through a data transmission device; a social data organization model operable to provide notifications between a first user and a second user when the first and second users are identified as friends; and a game component cycle permitting users to play real risk monetary gambling games and free play games, the game component cycle tracking the user's account balance during game play.

In another aspect of the present invention, computer software, written in one or more computer codes and stored on a computer readable medium, the computer software including computer code segments adapted to perform the steps of permitting users to register with a social gaming engine via an internet connection through a data transmission device; providing notifications between a first user and a second user when the first and second users are identified as friends within the social gaming engine; and permitting users to play real risk monetary gambling games and free play game; and tracking the user's account balance during game play.

In a further aspect of the present invention, a method for social networking on a gaming internet site comprises creating an account with a monetary social gaming engine, the monetary social gaming engine permitting a user to play social games for free and real risk monetary gambling games; making connections with friends on the gaming internet site, the connections permitting the user to join their friends at a game through a real time invitation or be notified of a game through a real time notification; and allowing users to chat and participate in discussions on the social gaming internet site.

These and other features, aspects and advantages of the present invention will become better understood with reference to the following drawings, description and claims.

### BRIEF DESCRIPTION OF THE DRAWINGS

FIG. 1 is a flow chart showing a monetary social gaming engine according to an exemplary embodiment of the present invention;

FIG. 2 is a flow chart showing the use of virtual credits/tokens according to an exemplary embodiment of the present invention;

FIG. 3 is a flow chart showing a gambling component cycle according to an exemplary embodiment of the present invention;

FIG. 4 is a continuation of the flow chart of FIG. 3;

FIG. 5 is a flow chart showing a profile data loop according to an exemplary embodiment of the present invention;

FIG. 6 is a flow chart showing a data transmission service according to an exemplary embodiment of the present invention; and

FIG. 7 is a flow chart showing a real money social gaming aspect according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system that allows people to socially connect with and play games with their friends online for free and for real money. The system allows them to schedule group events where group gaming occurs, play in tournaments, play in various types of games such as person versus software games, person versus person games, person versus many people games, many people versus many people games, free games, real risk monetary gambling games and any combination of any of the like. Person to person chat, person to people chat and people to people live group discussions can take place. Social connections, subscriptions, and other key data points, such as notifications of important events between friends which can be gathered from the profile data loop, are then analyzed and organized using the social data organization model (SDOM) to deliver a personalized data feed (PDF), recommendations, real time notifications (RTN) and real time invitations (RTI) which drives social gaming/gambling and solves the social gaming need of play free games and real money gambling games remotely over the internet together in one environment.

An optional API allows for external development for this free and real money social gaming engine and when used it turns the monetary social gaming engine (MSGE) into a monetary social gaming engine/platform (MSGEP). Therefore, in addition to the MSGE which is a new invention in its own right by providing real money social gambling (RMSG), the additional API, allowing external development of monetary gambling to integrate within the MSGE, transforms the MSGE into the Monetary Social Gaming Engine/Platform (MSGEP).

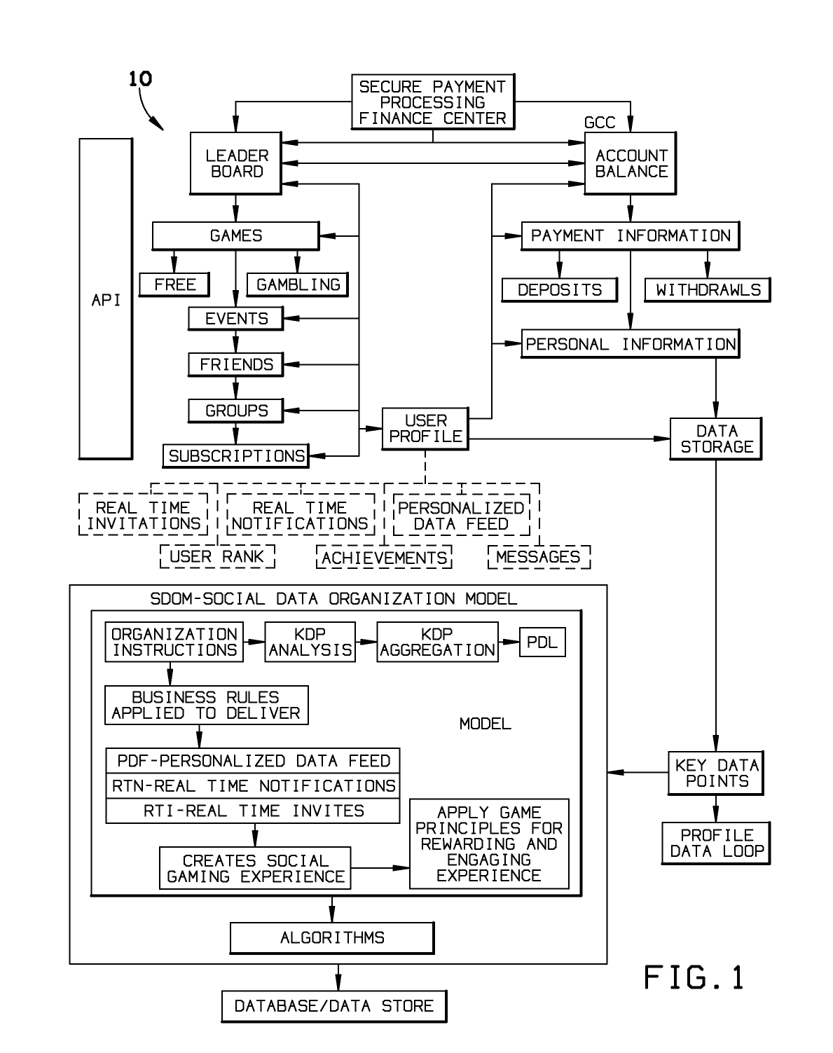

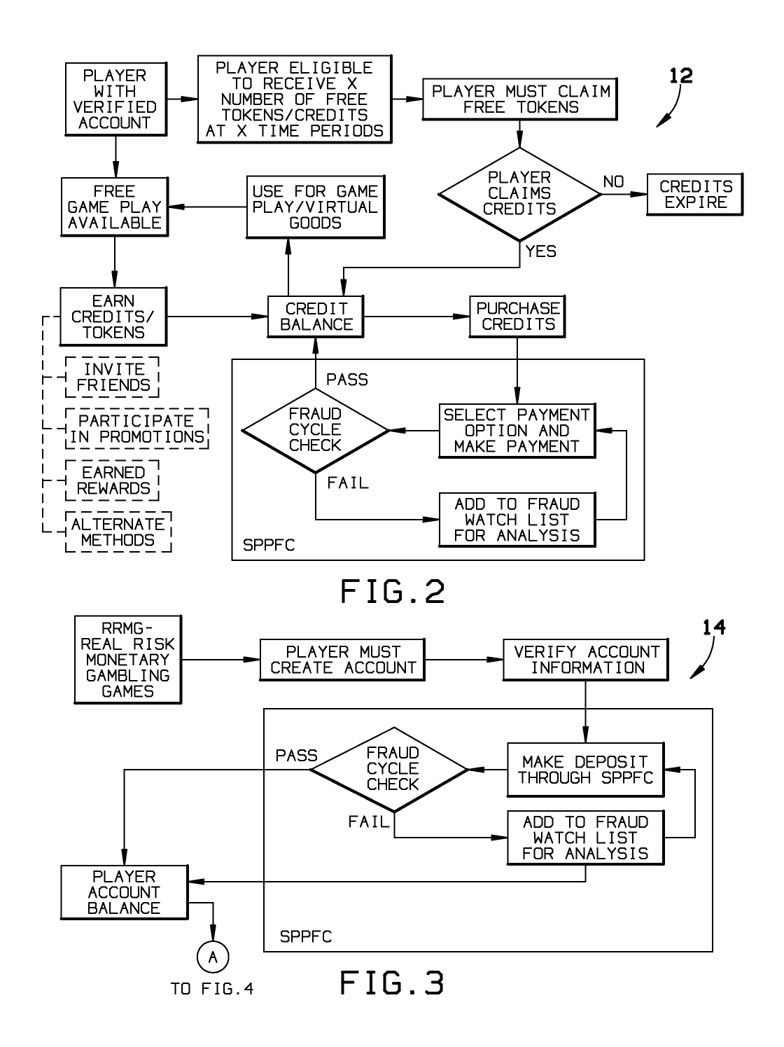

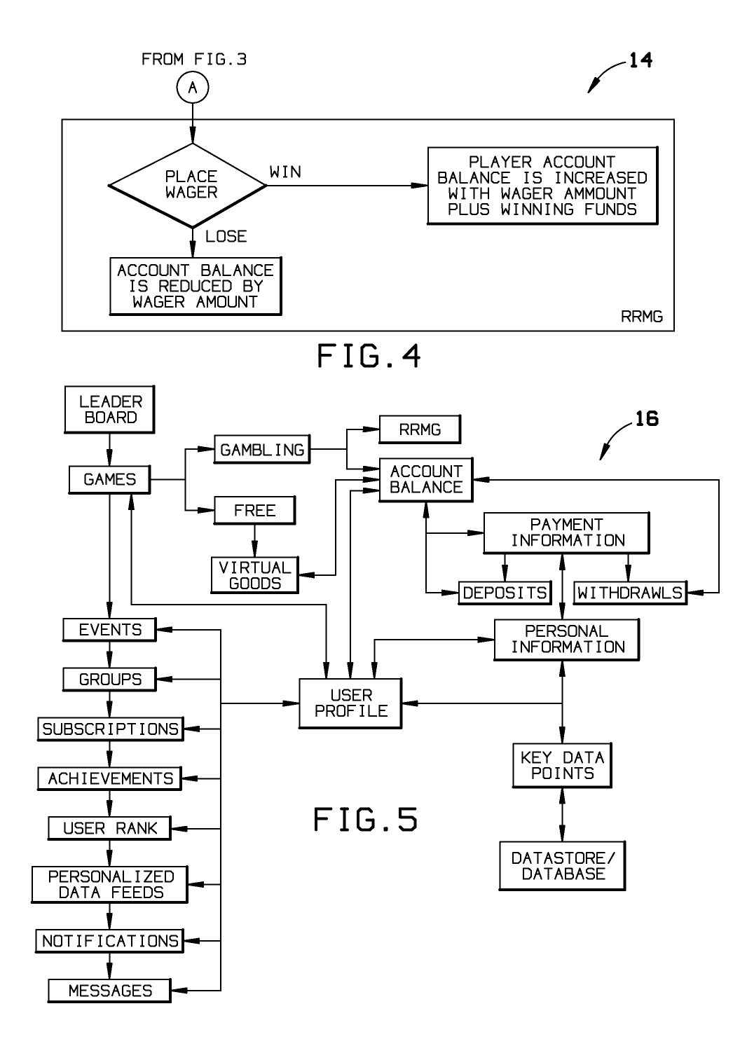

The system of the present invention provides user the opportunity to create a member account with personal profile, payment details, and the like. The member account would hold the member's account balance, gaming history or financial transaction history for example. The system provides games, both free and real risk monetary gambling (RRMG) (see FIGS. 3 and 4) and real money social gambling (RRSG) (see FIG. 7) with a virtual credits system (see FIG. 2) powered by a monetary social gaming engine (MSGE) 10 as shown in FIG. 1.

Gambling games can include person versus person wagers, person versus people wagers, people versus people wagers, person versus software wagers, event and outcome betting, progressive jackpots, tournaments, live gambling, and the like These can include traditional casino gambling games such as blackjack, slot machines, poker, roulette and other traditional gambling games. They can also include non traditional gambling games such as person to many people wagering, where one person can post a wager and many different people can each choose to accept the wager individually. This non traditional gambling game example is only used for illustrative purposes and is not limiting. Gambling games involve real monetary risk and are referred to as real risk monetary gambling (RRMGG).

Referring now to FIGS. 1 through 7, within the Gambling Components Cycle (GCC) there is integrated software (SPPFC—secure payment processing finance center) which facilitates secure payments via a number of methods including credit cards, debit cards, bank account, echecks, wire transfers, online payment wallets, virtual credits and register their method of payment for withdraw money from the software. GCC also includes RRMG and RMSG gambling. The GCC is described in the flow charts of FIGS. 3 and 4.

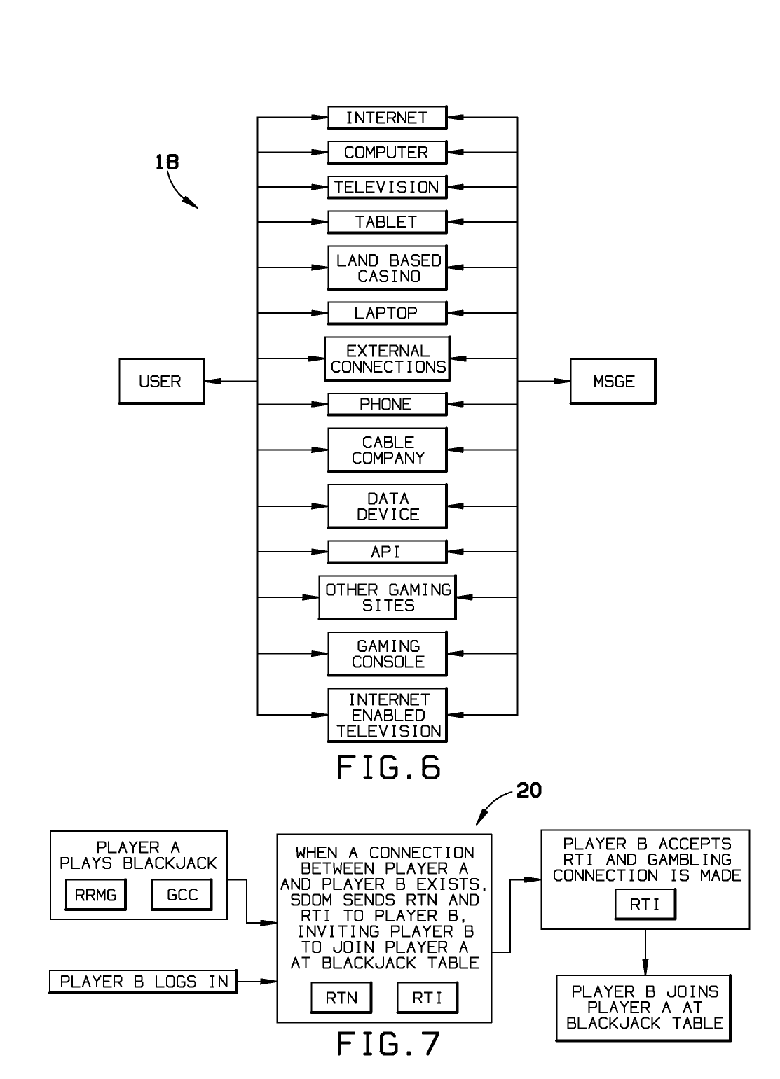

The DTD (Data Transmission Device) can be a variety of devices, such as a computer, a mobile device, a tablet, a television or any other data transmission device (DTD) with internet access. Examples of DTDs are shown in FIG. 6.

If a friend connection or data connection is present, then the SDOM can send relevant data via the personalized data feed (PDF) about friend's game played or other relevant data, real time notifications (RTN) about friend's current game play or other relevant data and send real time invitations (RTI) to connect the players so they can play together. This social gaming/gambling experience is powered through the SDOM logic applied after analyzing the key data points (KDPs) gathered via the PDL. Other KDPs include but are not limited to friend's jackpots won, friend's tournaments entered, games played, games liked, win/loss history and the like. If the friend is online, a user may join the friend's game, send group invites to group game play events, and the like. If a player is logged in, they are provided a feed of relevant social gaming data points based on their friends, social connections, subscriptions, and history. The SDOM can calculate game recommendations to deliver via the PDF based on player history and other recommendation algorithms. The system of the present invention includes free games and real money gambling combined into a single social gaming environment that ties it all together.

If the player elects to wager for real money, then the social gaming engine can provide real risk monetary gambling games and can process payments to and from the player in a safe and secure manner. The system of the present invention does this through the gambling components cycle (GCC) with the (SPPFC) component. If players elect to wager for real money, they must register with one of many possible payment secure methods, including credit cards, debit cards, bank account, echecks, wire transfers, online payments wallets, virtual credit, or the like, and register their method of payment for any real money cashouts. If players elect to share information with external developers via the API, data points can be shared and developed upon externally and those externally developed free or real risk gambling RRMG games/applications are able to be integrated within the social gaming engine.

If the player accomplishes assigned tasks, they can earn rewards, points, badges, and the like. This is a gamification logical element that will reward player for achievements and further engagement.

There are social elements of friend connections, content subscriptions, group events, play with friends, private messaging, chat, personalized data feeds, real time notifications, real time invitations, leaderboards, member ranking and achievements/badges and gaming elements of free games and real risk monetary gambling games. The (SDOM) strategically combines these elements to create a monetary social gaming engine (MSGE) (see FIG. 1) that offers both free social games and real money social gambling (RMSG) from the internet, mobile devices, television or other data transmission devices (DTD).

The real risk monetary gambling component (RRMG) is a new element added onto the free social gaming element and secured payment processing can be integrated to facilitate real money gambling. This is described in the gambling components cycle (GCC) of FIGS. 3 and 4.

The monetary social gaming engine (MSGE) provides the ability for person to software betting as well as peer to peer betting. The optional API allows for external development of free games and real risk monetary gambling games to integrated with the monetary social gaming engine/platform (MSGEP).

The present invention, including the monetary social gaming engine (MSGE), is capable of offering both free social games and real money social gambling games (RMSG) that algorithmically connects friends, allows them to play games together remotely, algorithmically shares critical data points, monitors each other's game play and allows to people play group games together. The system can use logic in the SDOM to power social gaming/gambling play/connections. The system can combine the real risk monetary gambling (RRMG) and social networking aspects together to create real money social gambling (RMSG) and provide the GCC—real money gambling games/applications, player profile and the necessary payment processing required to facilitate the real money gambling on the internet, mobile devices, television and other data transmission devices (DTD).

The system of the present invention can be made by a person skilled in the arts of web development with regards to web servers, databases, game development, social network development and integrating secure payment processing. The person with these required skills would then write software which will create the described MSGE and establish a webserver(s) and database(s) or or other data store types to run the algorithms. The monetary social gaming engine (MSGE) that connects friends, allows for remote social game play on the internet, mobile devices, televisions and other DTDs for free gaming and real risk monetary gambling (RRMG) with friends (RMSG) with secured payment processing (SPPFC) inside of the (GCC) is essential. This monetary social gaming engine offering both free and real money social gambling (RMSG) with friend connections, personalized data feeds, real time notifications, real time invitations, game recommendations based on player history and player connections is an original product and does not currently exist, therefore is absolutely necessary. The API is not required for the monetary social gaming engine, however, when added onto the newly created monetary social gaming engine (MSGE), it turns the (MSGE) into a monetary social gaming platform (MSGEP), allowing for free and (RRMG) external game development to be integrated within the real money social gaming environment.

To use the system of the present invention, a person would create an account with the monetary social gaming engine. Once an account has been created and the person has logged in, they are able to make friend connections and play social games with friends for free. They also have the ability to play real risk gambling games with real money for a chance to win real money (RRMG). Social gaming means they have friend connections and data connections established and the person is able to socially connect with their friends and others while playing social games with friends and the community from the internet, mobile devices, televisions, tablets or other DTDs. The person is able to instantly join their friends at a game through a RTI or join a group game as they will be notified via a RTN and algorithmically connected via the various social networking components of the real money social gaming engine. The person has the option to play games for free or play for real money (RRMG), where they are can securely make payments via a number of approved, secure payment options provided in the GCC. The person is also able to cash out real money winnings and receive payments via a number of approved payment options. The person can subscribe to a number of elements, establish friend connections, receive personalized data feeds, RTN, RTI, play social games for free, play social games for real money, rise in the player levels within the social gaming engine as they play more games and accomplish more tasks.

The monetary social gaming engine/platform (MSGEP) creates a social gaming environment where people can remotely and/or socially play games for free or play real money gambling games/applications with friends and other community members and be algorithmically connected in real time to their friends, interests, subscriptions, and other relevant data sets and gaming abilities via the internet, mobile devices, televisions and other data transmission devices.

It should be understood, of course, that the foregoing relates to exemplary embodiments of the invention and that modifications may be made without departing from the spirit and scope of the invention as set forth in the following claims.

What is claimed is:

1. A social gaming engine comprising:
a registration system operable to permit users to register with the social gaming engine via an internet connection through a data transmission device;
a profile data loop operable to store key data points relevant to the user;
a social data organization model operable to provide notifications between a first user and a second user when the first and second users are identified as friends;
a social data organization model operable to provide personalized data feeds to each member based on their unique profile data loop; and
a game component cycle permitting users to play real risk monetary gambling games and free play games, the game component cycle tracking the user's account balance during game play.

2. The social gaming engine of claim 1, wherein the game component cycle further includes software operable to provide payment processing for the users.

3. The social gaming engine of claim 1, wherein the social data organization model provides real time notifications and real time invitations about friends and key data points.

4. The social gaming engine of claim 1, wherein the social data organization model provides a personalized data feed to the users based on key data points.

5. The social gaming engine of claim 1, further comprising an application programming interface (API) creating a monetary social gamine engine/platform.

6. Computer software, written in one or more computer codes and stored on a computer readable medium, the computer software including computer code segments adapted to perform the steps of:
permitting users to register with a social gaming engine via an internet connection through a data transmission device;
providing notifications between a first user and a second user when the first and second users are identified as friends and/or data connected within the social gaming engine; and
permitting users to play real risk monetary gambling games and free play game; and
tracking the user's account balance during game play.

7. The computer software of claim 6, wherein the computer code segments are adapted to further perform the step of providing real time notifications and real time invitations among friends' activity and other key data points identified by the monetary social gaming engine.

8. The computer software of claim 6, wherein the computer code segments are adapted to further perform the step of providing a personalized data feed to the users based on key data points.

9. The computer software of claim 6, wherein the computer code segments are adapted to further perform the step of creating a monetary social gamine engine/platform via an application programming interface (API) included in the social gaming engine.

10. The computer software of claim 6, wherein the computer code segments are adapted to further perform the step of providing community leaderboards to the users based on individual member ranking across various events and tournaments.

11. A method for social networking and social gaming on a gaming internet site, platform or application, the method comprising:
creating an account with a monetary social gaming engine, the monetary social gaming engine permitting a user to play social games for free and real risk gambling games;
making connections with friends on the gaming internet site, the connections permitting the user to join their friends at a game through a real time invitation or be notified of a game through a real time notification; and
allowing users to chat and participate in discussions on the a gaming internet site, platform or application.

12. The method of claim 10, further comprising allowing users to schedule group events.

13. The method of claim 10, further comprising allowing users to create and participate in member(s) to member(s) direct wagering.

14. The method of claim 10, further comprising processing payments from and to users through the gaming internet site, the payments reflected in a user's account balance.
